(19) United States
(12) Patent Application Publication
(10) Pub. No.: US 2009/0137061 A1
(43) Pub. Date: May 28, 2009

(54) DETECTING MOLECULES

(75) Inventor: Mark S. Baker, North Ryde (AU)

Correspondence Address: MORGAN, LEWIS & BOCKIUS, LLP, ONE MARKET SPEAR STREET TOWER, SAN FRANCISCO, CA, 94105, US

(73) Assignee: Macquarie University, North Ryde (AU)

(21) Appl. No.: 11/813,443

(22) PCT Filed: Jan. 6, 2006
(86) PCT No.: PCT/AU06/00014

§ 371 Date: Jun. 9, 2008

(30) Foreign Application Priority Data
Jan. 6, 2005 (AU) 2005900048

(51) Int. Cl. G01N 1/18

(52) U.S. Cl. 436/177

(57) ABSTRACT

The invention relates to separating molecules, in particular, to proteins comprised in biological fluid such as serum, to purifying molecules and to producing antisera to molecules.

### TECHNICAL FIELD

The invention relates to separating molecules, in particular, to proteins comprised in biological fluid such as serum, to purifying molecules and to producing antisera to molecules.

### BACKGROUND

One common characteristic of biological samples, such as cell and tissue lysates, serum samples etc. and other complex samples of molecules, is that the molecules comprised in these samples are not represented equally in terms of their relative abundance. For example, albumin constitutes more than 50% of the protein in total serum whereas transthyretin constitutes about 0.3%.

One consequence is that, notwithstanding the many techniques for separation of samples of molecules, where two or more molecules have a common characteristic and are separated according to that characteristic, it is difficult to distinguish the less abundant molecule in the presence of the other more abundant molecule. Importantly, it is difficult, and may well indeed be impossible, to detect the molecule that has the lower relative abundance. For example, where molecules are separated according to molecular weight and charge or some other inherent chemical property, as in 2 dimensional gel electrophoresis, it is very difficult to detect a molecule having a low relative abundance in the sample in the circumstance where a molecule having a high relative abundance and the same or similar molecular weight and charge is also present in the sample.

Thus a limitation applies to the applicability of techniques such as 2 dimensional gel electrophoresis or multi-dimensional liquid chromatography for permitting identification of molecules that have a low relative abundance in a complex sample. This limitation is a significant barrier to the discovery of molecules in fields such as proteomics.

One approach to improving the capacity of 2 dimensional gel electrophoresis and similar arraying techniques for identification of proteins is to deplete molecules from a sample that have a high relative abundance by selecting known or otherwise commercially available antibodies to deplete proteins having a high relative abundance before conducting 2 dimensional gel electrophoresis.

A problem with this approach is that the depletion of high abundance proteins is limited by the content and specificity of the panel of known or otherwise commercially available antibodies available for selection. Accordingly, the only high relative abundance proteins that can be depleted are those for which the antibodies are known or are otherwise commercially available. Further, proteins that have a lower relative abundance than those depleted by this approach, and that have a higher relative abundance than the protein of interest, may not be depleted if the antibodies for binding to these proteins are not available.

A further problem is that in many biological fluids, the proteins that have the higher relative abundance may not be known or otherwise, no antibodies may be available to bind to these. Accordingly it is not possible to deplete the proteins having a high relative abundance from these samples using this approach.

Another problem with this approach is that it is expensive and requires a degree of technical manipulation to prepare the known or otherwise commercially available antibodies to be used for depletion. While depletion would be assisted by using antibodies that bind to different epitopes of the same protein, in practice it is very difficult to prepare a composition including more than one antibody for each protein to be depleted, for the depletion of more than one high abundance protein.

There is a need for an improvement in the identification or detection of molecules that have a low relative abundance in a sample.

### SUMMARY

In certain embodiments there is provided a process for increasing the relative abundance of a target molecule in a test sample. The process includes the following steps:
providing conditions for denaturing a molecule in a test sample to a test sample;
utilising the test sample to produce a first group of antibodies for binding to at least one species of molecule in the test sample that has a higher relative abundance in the test sample than a target molecule of the test sample;
utilising the first group of antibodies to deplete from the test sample at least one species of molecule that has a higher relative abundance in the test sample than the target molecule, to produce a first depleted sample;
utilising the first depleted sample to produce a second group of antibodies for binding to at least one species of molecule in the first depleted sample that has a higher relative abundance in the first depleted sample than the target molecule; and
utilising the first and second groups of antibodies to deplete from the test sample at least one species of molecule that has a higher relative abundance in the test sample than the target molecule, to increase the relative abundance of the target molecule in the test sample.

In other embodiments there is provided a process for increasing the relative abundance of a target molecule in a test sample. The process includes the following steps:
utilising the test sample to produce a first group of antibodies for binding to at least one species of molecule in the test sample that has a higher relative abundance in the test sample than a target molecule of the test sample;
utilising the first group of antibodies to deplete from the test sample at least one species of molecule that has a higher relative abundance in the test sample than the target molecule in conditions in which a molecule in the test sample is denatured, to produce a first depleted sample;
utilising the first depleted sample to produce a second group of antibodies for binding to at least one species of molecule in the first depleted sample that has a higher relative abundance in the first depleted sample than the target molecule; and
utilising the first and second groups of antibodies to deplete from the test sample at least one species of molecule that has a higher relative abundance in the test sample than the target molecule, to increase the relative abundance of the target molecule in the test sample.

In other embodiments there is provided a process for increasing the relative abundance of a molecule having a low relative abundance in a test sample. The process includes the following steps:
providing conditions for denaturing a molecule in a test sample to a test sample;
fractionating the test sample according to a property of the molecules of the test sample, to form at least two fractions of the test sample;
providing a population of hosts for producing a group of antibodies for binding to molecules of the test sample that have a high relative abundance in each fraction of the test sample;
introducing each fraction of the test sample into a host of the population so that each host of the population receives one of the fractions of the test sample, to produce a group of antibodies;
utilising the group of antibodies to deplete molecules from the test sample, to increase the relative abundance of a molecule having a low relative abundance in the test sample.

In other embodiments there is provided a process for increasing the relative abundance of a molecule having a low relative abundance in a test sample. The process includes the following steps:
fractionating the test sample according to a property of the molecules of the test sample, to form at least two fractions of the test sample;
providing a population of hosts for producing a group of antibodies for binding to molecules of the test sample that have a high relative abundance in each fraction of the test sample;
introducing each fraction of the test sample into a host of the population so that each host of the population receives one of the fractions of the test sample, to produce a group of antibodies;
utilising the group of antibodies to deplete molecules from the test sample in conditions in which a molecule in the test sample is denatured, to increase the relative abundance of a molecule having a low relative abundance in the test sample.

Also provided are processes for producing purified forms of low relative abundance molecules, for producing antibodies to low relative abundance molecules and to low relative abundance molecules, antibodies and kits containing same.

### BRIEF DESCRIPTION OF THE DRAWINGS

FIG. 1. A representation of a preferred process for increasing the relative abundance of molecules.

FIG. 2. 2 dimensional electrophoresis gel showing removal of high abundance proteins.

FIG. 3. (3A) A graphical representation of the concentration of proteins in plasma. (3B) A graphical representation of the concentration of proteins in plasma. The area marked by the dashed box indicates plasma proteins that can be visualised by 2 dimensional gel electrophoresis without immunodepletion, or in other words without immunosubtraction. (3C) A graphical representation of the concentration of proteins in plasma. The area marked by the dashed box in the lower right corner indicates the immunodepletion required to identify proteins having a low relative abundance. (3D) A graphical representation of the concentration of proteins in plasma. The filled in box marked “1” represents plasma proteins that are depleted after 1 round of depletion and without fractionation. (3E) A graphical representation of the concentration of proteins in plasma. The filled in boxes marked “1” and “2” represent plasma proteins that are depleted after 2 rounds of depletion and without fractionation. (3F) A graphical representation of the concentration of proteins in plasma. The filled in boxes marked “1”, “2” and “3” represent plasma proteins that are depleted after 3 rounds of depletion and without fractionation. (3G) A graphical representation of the concentration of proteins in plasma. The filled in boxes marked “1”, “2”, “3” and “4” represent plasma proteins that are depleted after 4 rounds of depletion and without fractionation. (3H) A graphical representation of the concentration of proteins in plasma. The filled in boxes marked “1”, “2”, “3”, “4” and “5” represent plasma proteins that are depleted after 5 rounds of depletion and without fractionation. (3I) A graphical representation of the concentration of proteins in plasma. The filled in box marked “1” represents plasma proteins that are depleted after 1 round of depletion and with fractionation. (3J) A graphical representation of the concentration of proteins in plasma. The filled in boxes marked “1” and “2” represent plasma proteins that are depleted after 2 rounds of depletion and with fractionation. (3K) A graphical representation of the concentration of proteins in plasma. The filled in boxes marked “1”, “2” and “3” represent plasma proteins that are depleted after 3 rounds of depletion and with fractionation. The representation demonstrates that after 3 rounds of depletion and fractionation, the proteins having a low relative abundance in plasma can be detected.

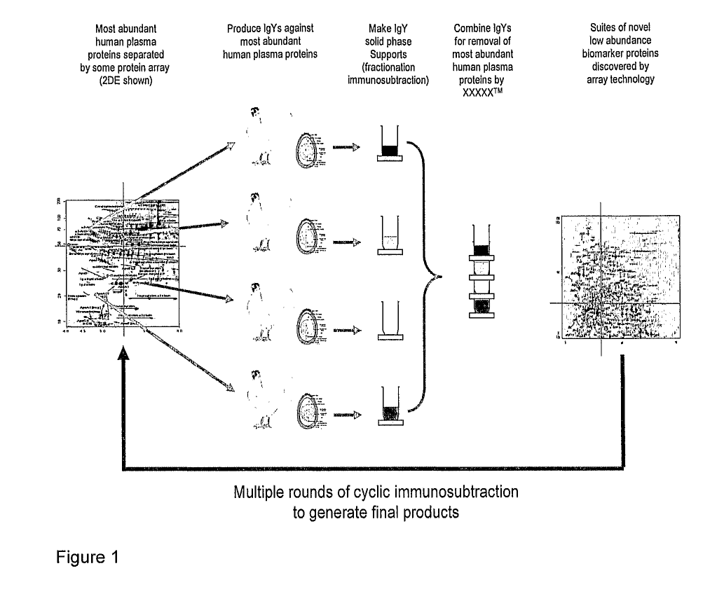

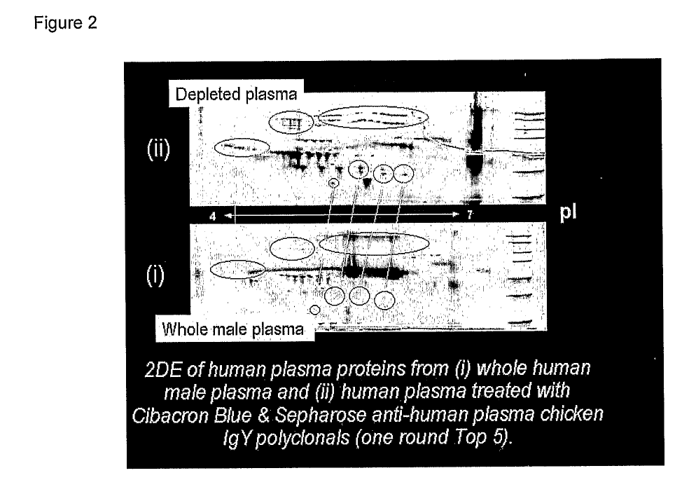

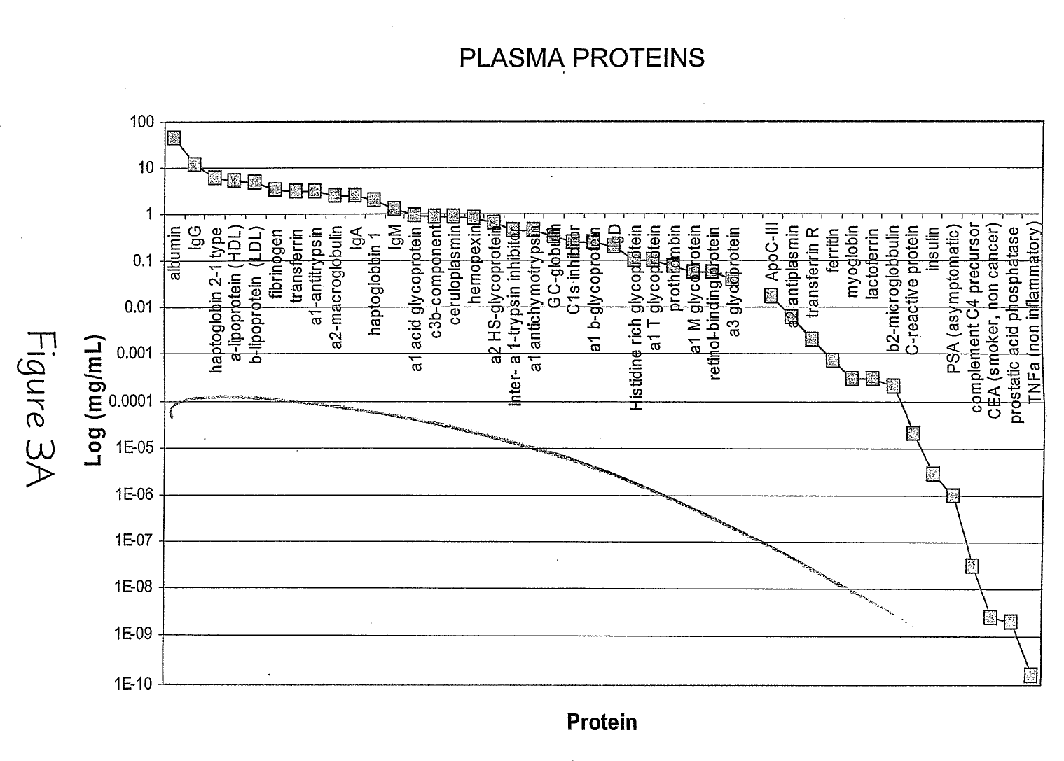

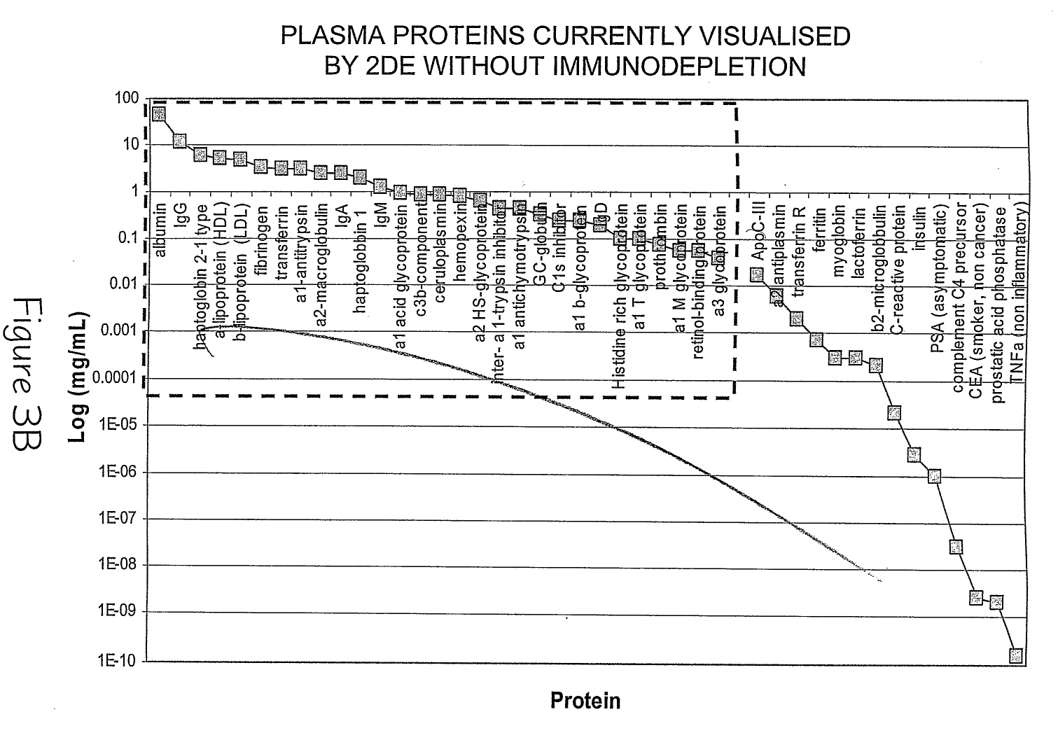

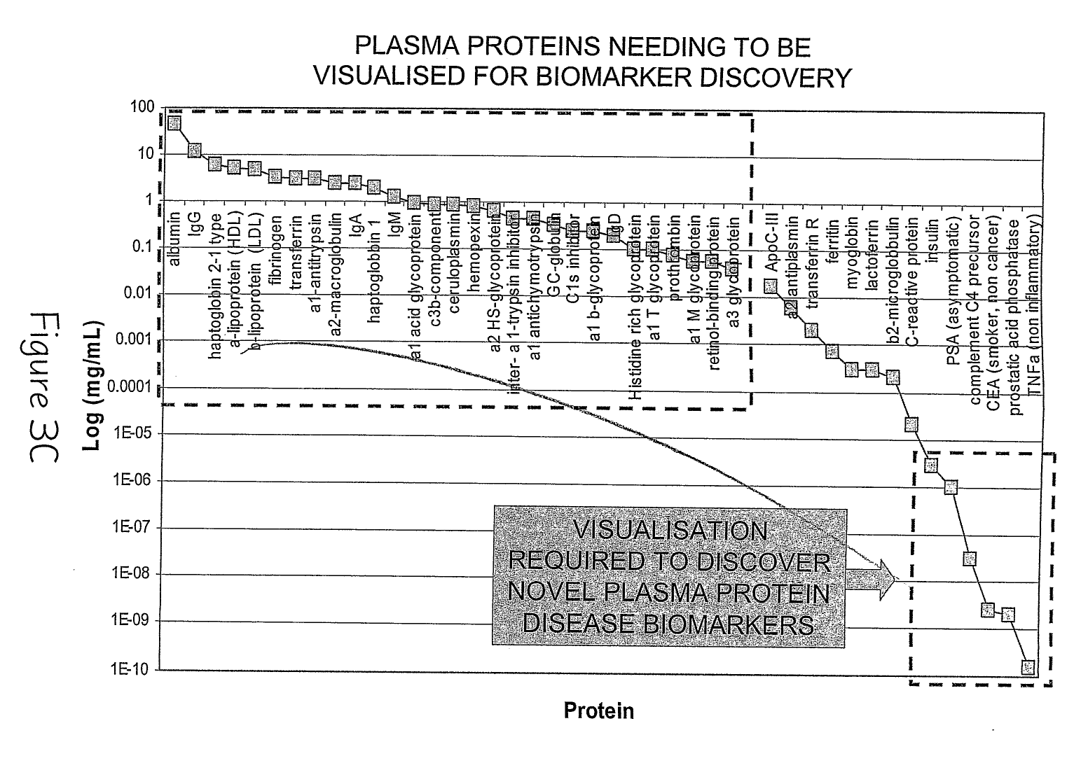

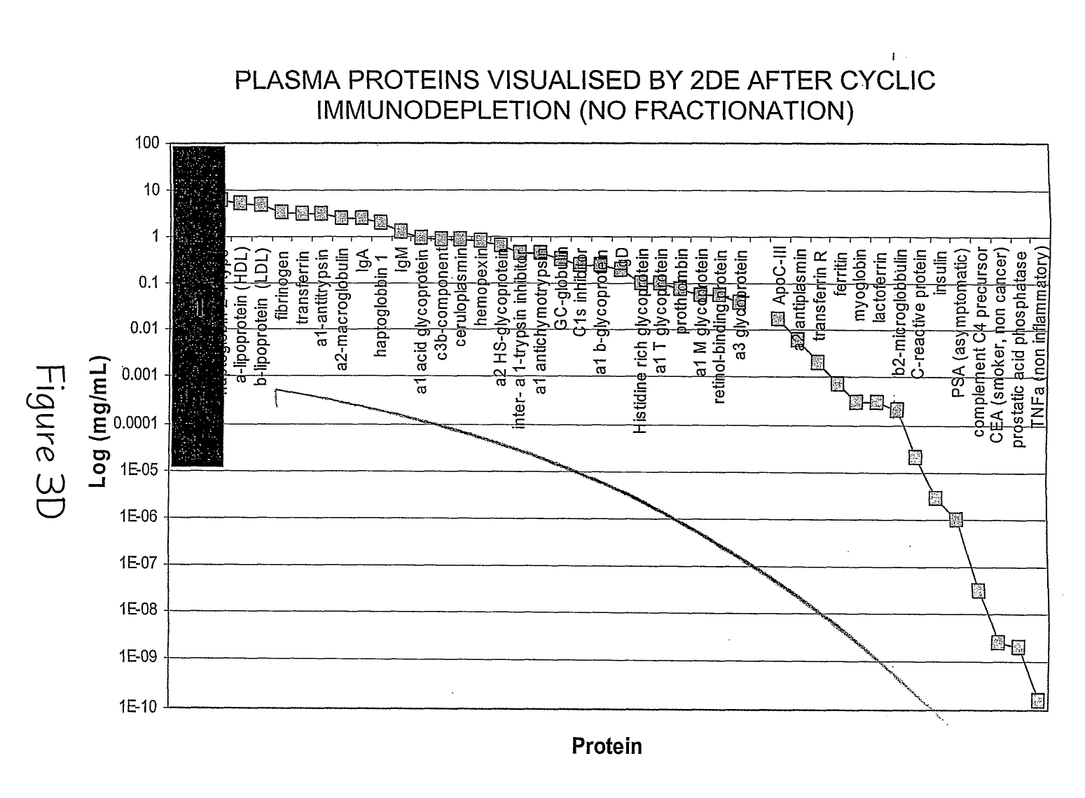

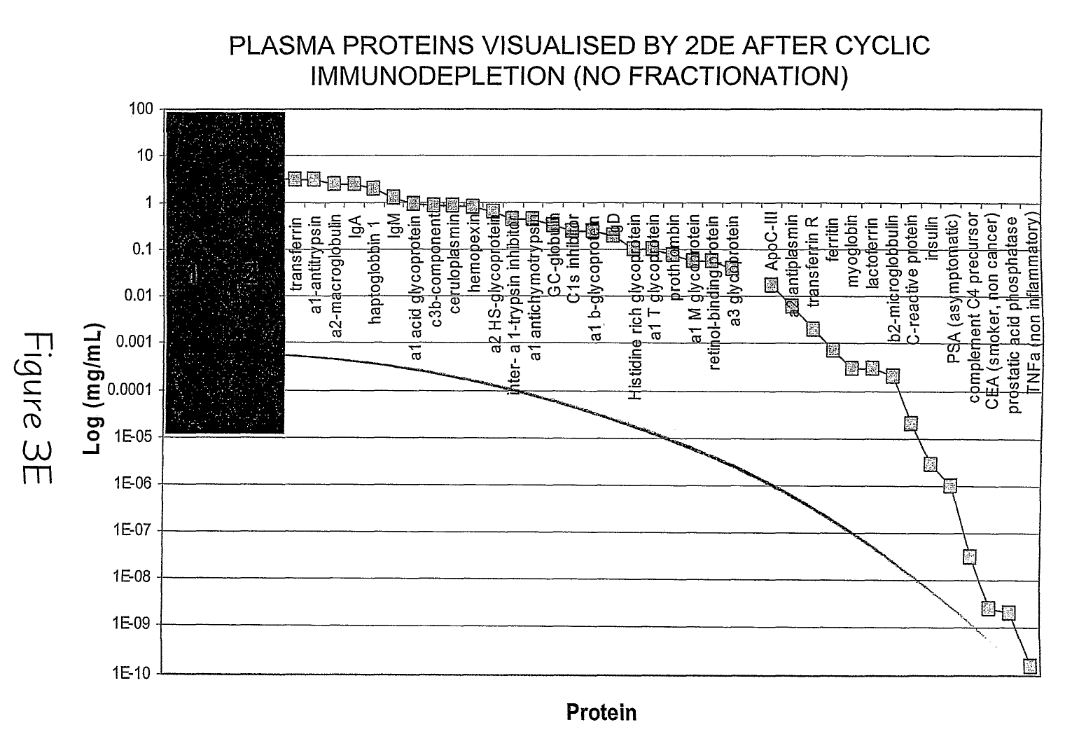

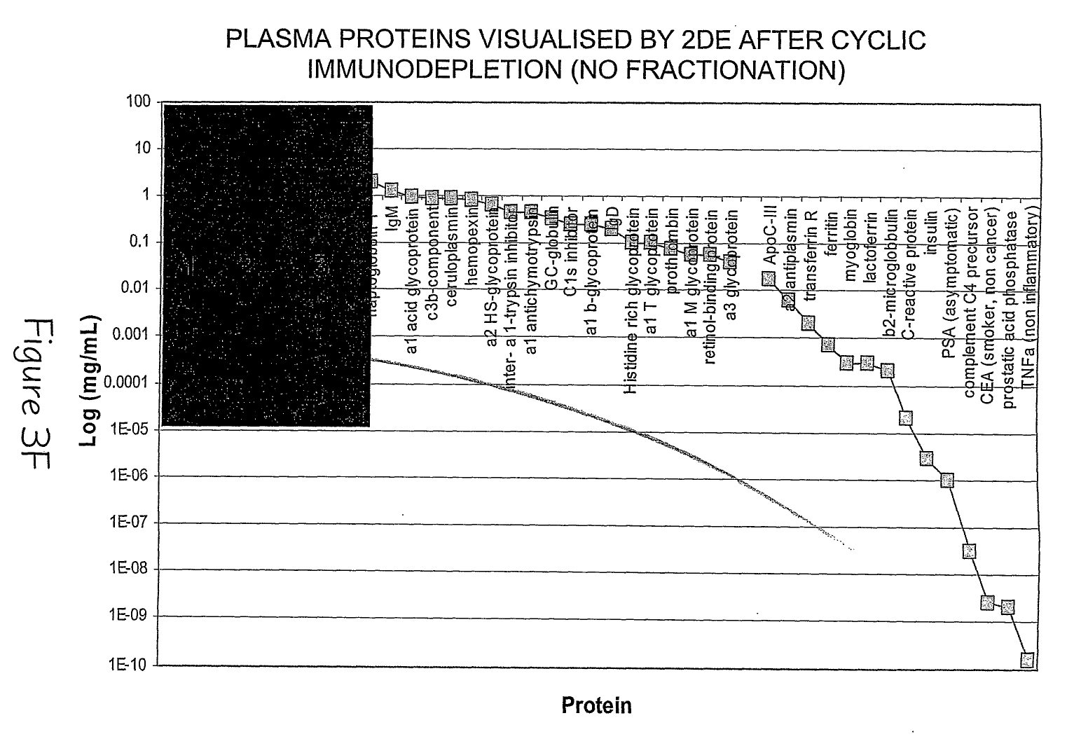

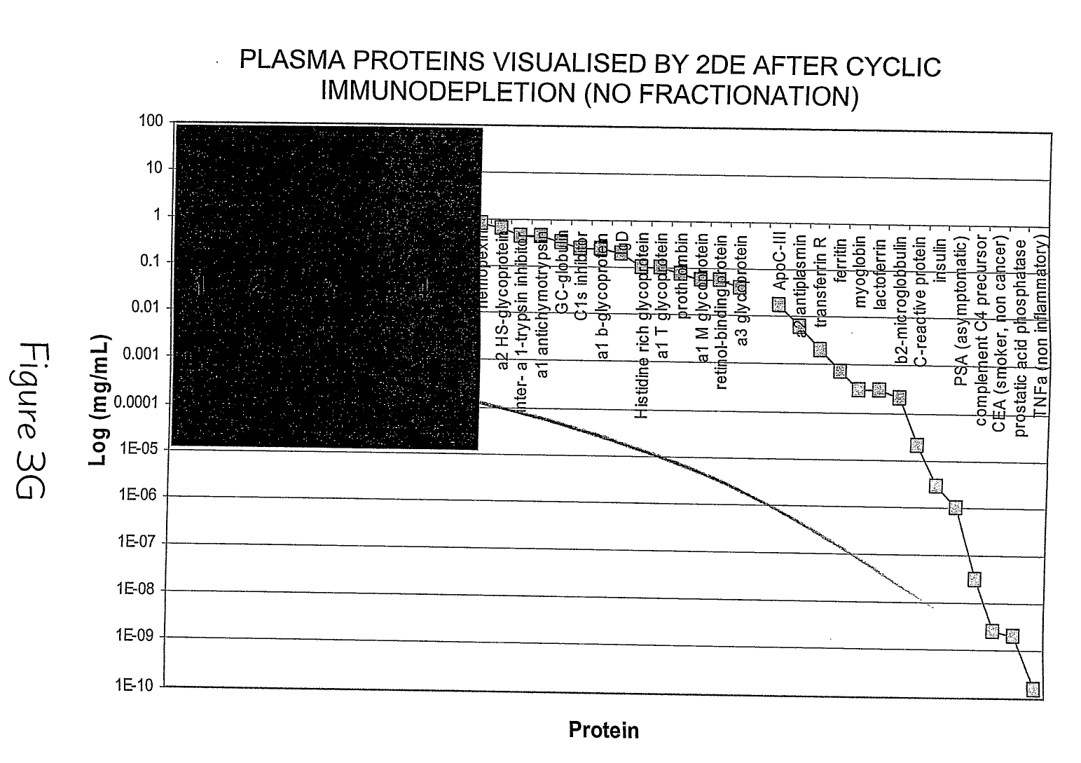

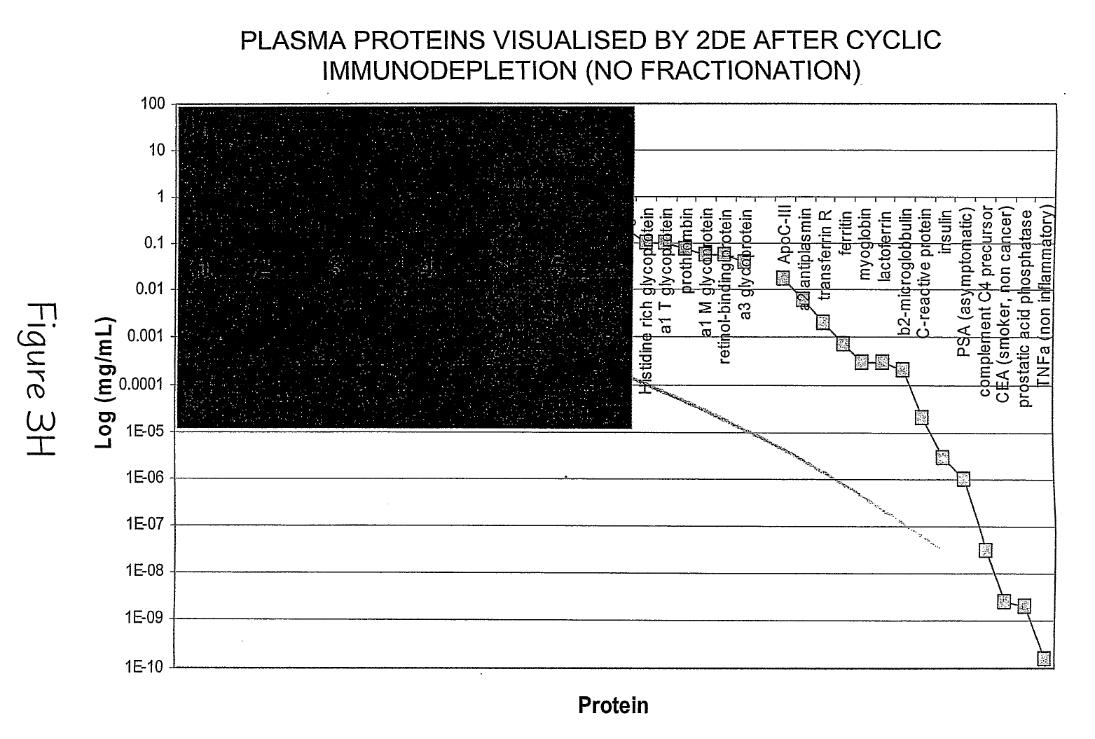

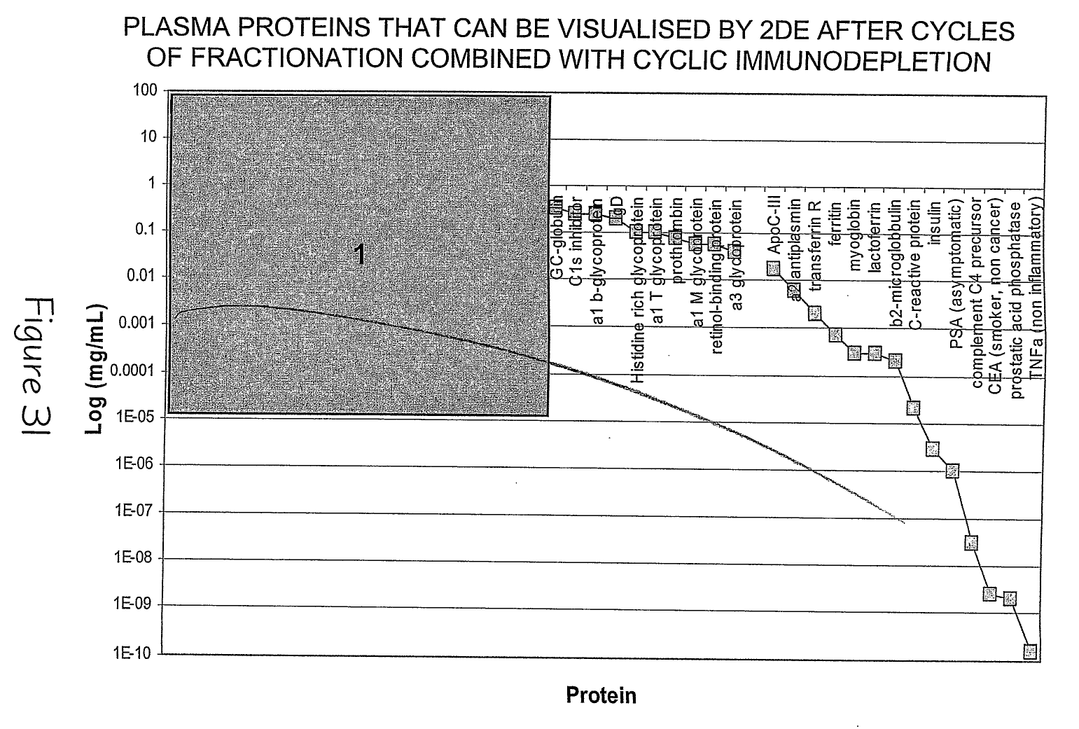

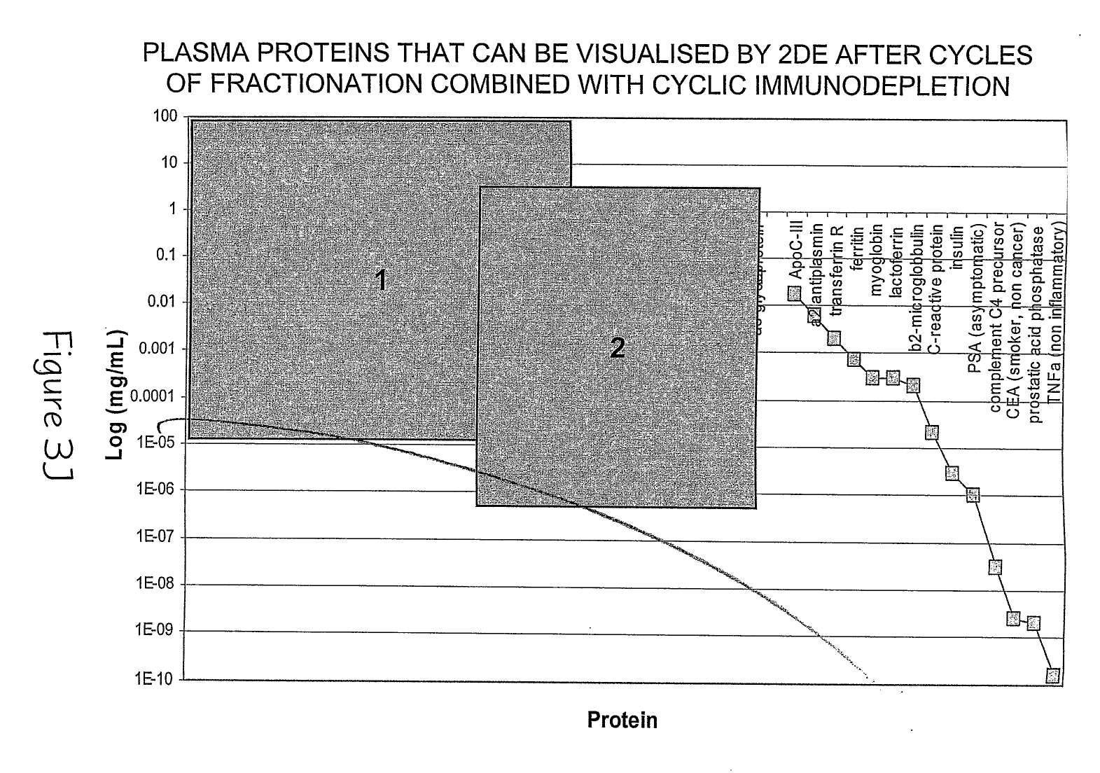

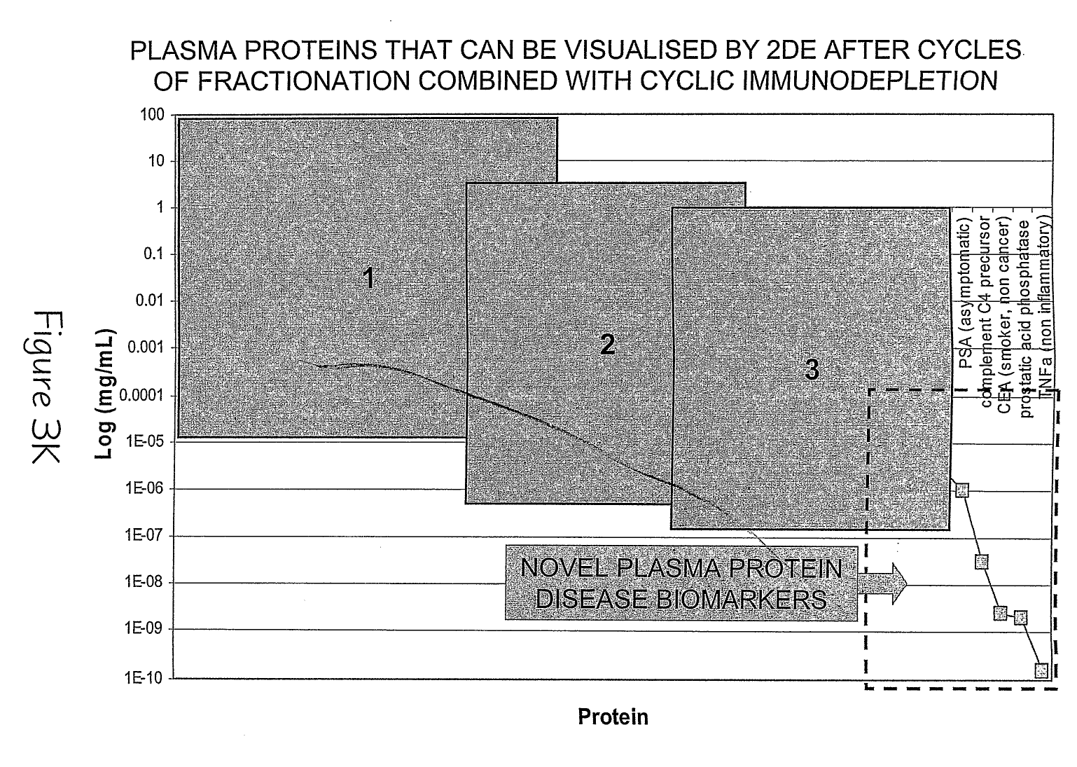

### DETAILED DESCRIPTION OF THE EMBODIMENTS

As described herein, the inventor has found that a molecule of interest, such as those molecules that have a low relative abundance in a test sample, for example a target molecule, can be identified or detected by depleting molecules from the test sample that have a higher relative abundance, or in other words, a higher relative amount or higher proportion than molecules having a lower relative abundance such as a target molecule. By depleting molecules that have a higher relative abundance, the relative abundance of the target molecule in the test sample is increased which in turn improves the ease with which such molecules can be identified or detected.

The increase in the relative abundance of the target molecule is achieved by using the test sample as an immunogen to produce antibodies that are then used to deplete molecules having a higher relative abundance than the target molecule from the test sample. The production of antibodies by immunising with the test sample is particularly advantageous because in the subsequent depletion step, it is possible to deplete molecules having a higher relative abundance from the sample without knowing the identity of these molecules. In other words, there is no need for knowledge of the molecules having a higher relative abundance in the test sample in order to deplete these from the sample. Thus a target molecule comprised in an otherwise poorly characterised test sample can be detected by the process.

A further advantage of using the test sample as an immunogen for producing antibodies that are then used to deplete molecules having a higher relative abundance is that it is possible to generate antibodies that are reactive with different epitopes on the same molecular species. Accordingly, the antibodies provided by the processes herein tend to have a greater capacity for depletion of high abundance molecules from a test sample.

According to the processes disclosed herein, denaturing conditions, i.e. conditions in which hetero- and homo-protein and/or peptide complexes tend to disassociate and/or in which native molecular conformations of complexes or monomers tend to be lost, are applied so as to provide denatured molecules for use in immunisation for raising antibodies to high abundance molecules and/or to provide denatured molecules for depletion during a subsequent depletion step. One advantage is that molecules that, but for denaturing conditions, tend to be associated with high abundance molecules can be dissociated from high relative abundance molecule and hence are not depleted by anti-high relative abundance molecule antibodies during subsequent depletion steps. Thus the fidelity of the processes herein for increasing the relative abundance of a molecule in a test sample can be controlled, without the concurrent loss of less abundant binding proteins or peptides.

For example, in non denaturing conditions, albumin, which is a molecule having a high relative abundance in serum samples, is typically bound to other molecules having a lower relative abundance. By providing denaturing conditions, it is possible to cause dissociation of the low relative abundance molecules from albumin and hence, during the step of depleting with anti-albumin antibodies, to deplete albumin only.

Another advantage is that the denaturing conditions lead to the formation of linear epitopes, rather than conformation epitopes, thus providing further diversity in antibody specificity and further improving the power of the depletion step for the removal of high relative abundance proteins from a test sample.

Process and reagents for providing denaturing conditions prior to immunisation and/or prior to depletion are described further herein.

In certain embodiments there is provided a process for increasing the relative abundance of a target molecule in a test sample including:

a) providing conditions for denaturing a molecule in a test sample to a test sample;

b) utilising the test sample to produce a first group of antibodies for binding to at least one species of a molecule in the test sample that has a higher relative abundance in the test sample than a target molecule of the test sample;

c) utilising the first group of antibodies to deplete from the test sample at least one species of a molecule that has a higher relative abundance in the test sample than the target molecule, to produce a first depleted sample;

d) utilising the first depleted sample to produce a second group of antibodies for binding to at least one species of molecule in the first depleted sample that has a higher relative abundance in the first depleted sample than the target molecule; and

e) utilising the first and second groups of antibodies to deplete from the test sample at least one species of molecule that has a higher relative abundance in the test sample than the target molecule, to increase the relative abundance of the target molecule in the test sample.

In one embodiment the process includes the further step of providing conditions for denaturing a molecule in the first depleted sample to the first depleted sample prior to step d).

It will be understood that steps d) and e) of the process are particularly important as the antibodies produced therein permit the depletion of molecules that have a lower relative abundance than the molecules depleted in step c) and yet a higher relative abundance than the target molecule. One particular advantage is that low abundance molecules can be made visible, for example by 2 dimensional gel electrophoresis, by the process.

One particularly important advantage of the process is that it can be performed in a fashion whereby molecules that have a higher relative abundance than the target molecule are sequentially removed in each subsequent depletion step. For example, and as described further herein, the steps of using a sample as an immunogen to produce antibodies that are then used to deplete molecules from a sample that have a higher relative abundance than the target molecule, thereby increasing relative abundance of the target molecule, can be repeated multiple times. Accordingly, molecules having a higher relative abundance are depleted and relative abundance of the molecules having the lower relative abundance is increased.

For example, for producing a third depleted sample, the process may include further steps of:

f) utilising the sample produced by the depletion of the test sample with the first and second groups of antibodies (i.e. utilising a “second depleted sample”) to produce a third group of antibodies for binding to at least one species of molecule in the second depleted sample that has a higher relative abundance in the second depleted sample than the target molecule; and

g) utilising the first, second and third groups of antibodies to deplete from the test sample at least one species of molecule that has a higher relative abundance in the test sample than the target molecule, to produce a third depleted sample.

Thus it will be understood that the sample produced from the depletion of the test sample with the first and second groups of antibodies, or the first pool of antibodies, can be used to produce third and further groups of antibodies, which can be used sequentially with the first and second groups of antibodies, or in a composition including the first pool of antibodies, to produce further depleted samples in which the relative abundance of the target molecule is increased.

Further, in certain embodiments the process includes the step of providing conditions for denaturing a molecule in a sample to a second depleted sample (for example, before step f) above), or to third fourth and further depleted samples.

It will be understood that the first and second groups of antibodies may be used sequentially to deplete from the test sample the at least one species of molecule that has a higher relative abundance in the test sample than the target molecule. In an alternative process, the first and second groups of antibodies are combined as in the form of a composition and the composition is then used to deplete from the test sample at least one species of molecule that has a higher relative abundance in the test sample than the target molecule.

Thus in another embodiment there is provided a process for increasing the relative abundance of a target molecule in a test sample including:

a) providing conditions for denaturing a molecule in a test sample to a test sample;

b) utilising the test sample to produce a first group of antibodies for binding to at least one species of a molecule in the test sample that has a higher relative abundance in the sample than the target molecule;

c) utilising the first group of antibodies to deplete from the test sample at least one species of a molecule that has a higher relative abundance in the test sample than the target molecule, to produce a first depleted sample;

d) utilising the first depleted sample to produce a second group of antibodies for binding to at least one species of molecule in the first depleted sample that has a higher relative abundance in the first depleted sample than the target molecule;

e) combining the first and second group of antibodies to form a first pool of antibodies; and

f) utilising the first pool of antibodies to deplete from the test sample at least one species of molecule that has a higher relative abundance in the test sample than the target molecule, to increase the relative abundance of the target molecule in the test sample.

In one embodiment the process includes the further step of providing conditions for denaturing a molecule in the first depleted sample to the first depleted sample prior to step d).

It will be understood that the sample produced from the depletion of the test sample with the first pool of antibodies, can be used to produce third and further groups of antibodies, which can be used sequentially with the first and second groups of antibodies, or in a composition including the first pool of antibodies, to produce further depleted samples in which the relative abundance of the target molecule is increased.

Thus where the process includes the step of forming a first pool of antibodies for use in depleting a species of molecule that has a higher relative abundance than the target molecule in the test sample, the process includes the further steps of:

g) utilising the sample produced by the depletion of the test sample with the first pool of antibodies (i.e. utilising a “second depleted sample”) to produced a third group of antibodies for binding to at least one species of molecule in the second depleted sample that has a higher relative abundance in the second depleted sample than the target molecule; and

h) utilising the first pool of antibodies and the third group of antibodies to deplete from the test sample at least one species of molecule that has a higher relative abundance in the test sample than the target molecule, to produce a third depleted sample.

In certain embodiments the process includes the step of providing conditions for denaturing a molecule in a sample to a second, third and fourth depleted sample.

In this embodiment, it will be understood that the first pool of antibodies and the third group of antibodies can be used sequentially, or alternatively, in the form of a composition, for example by combining the first pool of antibodies and the third group of antibodies to form a second pool of antibodies, to deplete from the test sample at least one species of molecule that has a higher relative abundance in the test sample than the target molecule.

It will be understood that one consequence of the depletion of molecules having a higher relative abundance than the target molecule is that in the depleted samples (for example, the first, second and further depleted samples), the amount of molecules is reduced. To maintain an appropriate amount of molecules to produce a group of antibodies to molecules that have a higher relative abundance than the target molecule, typically it is necessary to use the test sample as a source of depleted samples for producing antibodies to molecules that have a higher relative abundance than the target molecule. Alternatively, it may be possible to use a depleted sample as a source for further depleted samples i.e. it may be possible to use the first depleted sample as a source for a second and third depleted sample, or it may be possible to use the second depleted sample as a source for the third depleted sample, and the third depleted sample as a source for a fourth depleted sample and so on.

Thus in another embodiment there is provided a process for increasing the relative abundance of a target molecule in a sample including:

a) providing conditions for denaturing a molecule in a test sample to a test sample;

b) utilising the sample to produce a first group of antibodies for binding to at least one species of molecule in the sample that has a higher relative abundance in the sample than the target molecule;

c) utilising the first group of antibodies to deplete from the sample at least one species of molecule that has a higher relative abundance in the sample than the target molecule, to produce a first depleted sample;

d) utilising the first depleted sample to produce a second group of antibodies for binding to at least one species of molecule in the first depleted sample that has a higher relative abundance in the first depleted sample than the target molecule; and

e) utilising the second group of antibodies to deplete from the first depleted sample at least one species of molecule that has a higher relative abundance in the first depleted sample than the target molecule, to increase the relative abundance of the target molecule.

According to this embodiment, it will be understood that the sample produced from the depletion of the first depleted sample with the second group of antibodies (in this aspect of the invention, the “second depleted sample”), can be used to produce third and further groups of antibodies, which can be used to produce further depleted samples in which the relative abundance of the target molecule is increased.

Thus in one embodiment, the process includes the further steps of:

f) utilising the second depleted sample to produce a third group of antibodies for binding to at least one species of molecule in the second depleted sample that has a higher relative abundance in the second depleted sample than the target molecule; and

g) utilising the third group of antibodies to deplete from the second depleted sample at least one species of molecule that has a higher relative abundance in the second depleted sample than the target molecule, to produce a third depleted sample.

The process may include further steps of utilising the third depleted sample to produce further groups of antibodies for producing further depleted samples.

In one embodiment the process includes the further step of providing conditions for denaturing a molecule in the first depleted sample to the first depleted sample prior to step d).

Further, in certain embodiments the process includes the step of providing conditions for denaturing a molecule in a sample to a second depleted sample (for example, before step f) above), or to third fourth and further depleted samples.

In other embodiments there is provided a process for increasing the relative abundance of a target molecule in a test sample. The process includes the following steps:

a) utilising a test sample to produce a first group of antibodies for binding to at least one species of a molecule in the test sample that has a higher relative abundance in the test sample than a target molecule of the test sample;

b) utilising the first group of antibodies to deplete from the test sample at least one species of molecule that has a higher relative abundance in the test sample than the target molecule in conditions in which a molecule in the test sample is denatured, to produce a first depleted sample;

c) utilising the first depleted sample to produce a second group of antibodies for binding to at least one species of a molecule in the first depleted sample that has a higher relative abundance in the first depleted sample than the target molecule; and

d) utilising the first and second groups of antibodies to deplete from the test sample at least one species of molecule that has a higher relative abundance in the test sample than the target molecule, to increase the relative abundance of the target molecule in the test sample.

In one embodiment, in step d), conditions in which a molecule of the test sample is denatured are applied for depletion of high relative abundance molecules from the sample with the first and second groups of antibodies.

It will be understood that the sample produced from the depletion of the test sample with the first and second groups of antibodies, or the first pool of antibodies, can be used to produce third and further groups of antibodies, which can be used sequentially with the first and second groups of antibodies, or in a composition including the first pool of antibodies, to produce further depleted samples in which the relative abundance of the target molecule is increased.

Further it will be understood that conditions in which a molecule of the test sample is denatured may be applied for depletion with third and further groups or pools of antibodies to deplete molecule of high relative abundance from a sample.

In one embodiment, the process includes:

a) providing conditions for denaturing a molecule in a test sample to a test sample;

b) utilising the test sample to produce a first group of antibodies for binding to at least one species of molecule in the test sample that has a higher relative abundance in the test sample than a target molecule of the test sample;

c) utilising the first group of antibodies to deplete from the test sample at least one species of molecule that has a higher relative abundance in the test sample than the target molecule in conditions in which a molecule in the test sample is denatured, to produce a first depleted sample;

d) utilising the first depleted sample to produce a second group of antibodies for binding to at least one species of molecule in the first depleted sample that has a higher relative abundance in the first depleted sample than the target molecule; and

e) utilising the first and second groups of antibodies to deplete from the test sample at least one species of molecule that has a higher relative abundance in the test sample than the target molecule, to increase the relative abundance of the target molecule in the test sample.

Further, in certain embodiments the process includes the further step of providing conditions for denaturing a molecule in the first depleted sample to the first depleted sample prior to step d).

Further, in certain embodiments the process includes the step of providing conditions for denaturing a molecule in a sample to a second, third, fourth and further depleted samples.

The test sample for use in the processes herein may be further processed before use. For example, the test sample may be fractionated to remove molecules in the sample that have a particular physical characteristic. Thus, the test sample may be fractionated to remove molecules in the sample that have a particular molecular weight, hydrophobicity and/or molecular charge. Molecular weight chromatography, for example, using gel exclusion columns, anion exchange chromatography, isoelectric focussing or 2 dimensional gel electrophoresis could be used for this purpose.

Alternatively, the test sample may be fractionated to remove molecules that have a particular epitope. For example, the test sample may be contacted with one or more antibodies that bind to one or molecules in the test sample, to remove these molecules from the test sample. Examples of these antibodies include antibodies that bind to albumin, IgG, transferrin, haptoglobin, alpha 1 antitrypsin, alpha 2 macroglobulin, IgA, IgM, alpha 1 acid glycoprotein, hemopexin, alpha 2 HS glycoprotein, alpha 1 antichymotrypsin, transhyretin and apo A1 lipoprotein. US patent application no. 2002/0127739A describes a suitable immunosubtraction procedure for removing molecules that have a particular epitope.

Where the test sample contains glycoprotein, the test sample may be treated to remove carbohydrate.

Further, samples produced by the depletion of molecules having a higher relative abundance than the target molecule, for example the “first-”, “second-”, “third-” or “further depleted samples” could be processed as described above.

The test sample may be utilised to produce antibodies for binding to at least one molecule that has a higher relative abundance in the sample than the target molecule by immunising an organism with the whole of the test sample. Alternatively, one or more portions only may be used to immunise an organism. These portions may be prepared by a chromatographic procedure described above or other separation procedure. Still further, the test sample may be divided into portions, an organism immunised with a single portion, and antibodies collected from each organism so immunised and combined to produce the group of antibodies for depleting a molecule that has a higher relative abundance in the sample than the target molecule.

Further, samples produced by the depletion of molecules having a higher relative abundance than the target molecule, for example the “first-”, “second-”, “third-” or “further depleted samples” may be immunised as a whole as described above, or they may be immunised as a portion of the whole, using the chromatographic procedures described above.

Consistent with the preceding paragraphs, the inventor has found that it is particularly advantageous to combine cyclic immunosubtraction with prior fractionation, as described in the preceding paragraphs, because by this approach it is possible to produce an antisera that contains more antibody specificities and therefore, it is possible to produce an antisera that is capable of removing more higher relative abundance molecules from a test sample in each depletion step. Specifically, while not intending to limit the scope of the disclosure, the inventor believes that with immunisation of an unfractionated test sample, the antibodies that are produced tend to be those that bind to the 2 to 3 species of most abundant molecules in the test sample. Accordingly, in each depletion, only 2 to 3 species of higher relative abundance molecules are removed from the test sample.

From this, the inventor has reasoned that by introducing fractions of a test sample into a host so that each host receives one fraction, it should be possible to raise antibodies to many more species of higher relative abundance molecules in the test sample, because the antibodies produced in each host would bind to the 2 to 3 most abundant species of molecules in each fraction. Accordingly, where the test sample is fractionated into 2 fractions, 2 hosts are immunised, one host with one of the fractions and the other host with the other fraction, so that antibodies will be produced against 2 to 3 species of the most abundant molecules of the test sample in each host. Thus in total, 4 to 6 species of the high relative abundance molecules of the sample can be removed in the first depletion, instead of 2 to 3 species, as would otherwise occur where cyclic immunosubtraction is not combined with fractionation.

It will be understood that the greater the number of fractions, the greater number species of higher relative abundance molecules that can be removed in each depletion. For example, where the test sample is fractionated into 10 fractions, 10 hosts are immunised, each host with one of the fractions, so that antibodies will be produced against 2 to 3 species of the most abundant molecules of each fraction in each host. When these antibodies are used to deplete higher relative abundance molecules, 20 to 30 species of these molecules can be removed in one depletion.

Thus, the inventor has recognised that the very process of fractionating the test sample increases the relative abundance of molecules in each fraction so obtained. It is for this reason that the relative abundance of a target molecule in a sample can be markedly increased when fractionation is combined with cyclic immunosubtraction.

The inventor believes that by combining cyclic immunosubtraction with fractionation, fewer depletion steps are required to increase the relative abundance of a target molecule in a test sample. This means that less time and expense is required to detect, identify or purify these molecules. This is clearly an important advantage.

Thus in certain embodiments there is provided a process for increasing the relative abundance of a molecule having a low relative abundance in a test sample. The process includes the following steps:

a) providing conditions for denaturing a molecule in a test sample to a test sample;

b) fractionating the test sample according to a property of molecules of the test sample, to form at least two fractions of the test sample;

c) providing a population of hosts for producing a group of antibodies for binding to molecules of the test sample that have a high relative abundance in each fraction of the test sample;

d) introducing each fraction of the test sample into a host of the population so that each host of the population receives one of the fractions of the test sample, to produce the group of antibodies;

e) utilising the group of antibodies to deplete molecules from the test sample, to increase the relative abundance of a molecule having a low relative abundance in the test sample.

Typically the process includes the further steps of:

f) fractionating the first depleted sample according to a property of the molecules of the first depleted sample to form at least two fractions of the first depleted sample;

g) providing a second population of hosts for producing a second group of antibodies for binding to molecules of the test sample that have a high relative abundance in each fraction of the first depleted sample;

h) introducing each fraction of the first depleted sample into a host of the second population so that each host of the second population receives one of the fractions of the first depleted sample, to produce the second group of antibodies;

i) utilising the first group of antibodies and the second group of antibodies to deplete molecules from the test sample, to increase the relative abundance of a molecule having a low relative abundance in the test sample.

In one embodiment the process includes the further step of providing conditions for denaturing a molecule in the first depleted sample to the first depleted sample prior to step h).

It does not matter how many fractions are formed by fractionating the samples used in the process because as discussed above, the mere combination of fractionation with cyclic immunosubtraction has significant advantages for increasing the relative abundance of a target molecule in a sample over mere cyclic immunosubtraction. However, it will also be clear that the more fractions produced, the greater the power of the process to increase the relative abundance of a target molecule in a sample. Typically the test sample or other samples used in the process (for example, the first depleted sample) are fractionated to produce at least 10 fractions, although they may be fractionated to obtain fewer or more fractions than this.

It will be recognised that it is not necessary that all samples used in the process are to be fractionated into the same numbers of fractions. For example, it is not necessary that both the test sample, the first depleted sample, and subsequent depleted samples (if any) need to be fractionated 10 times each. Indeed in some circumstances, it is recognised that it may be more useful to fractionate some samples into greater numbers than others. For example, a test sample may be fractionated into 10 fractions, the first depleted sample may then be fractionated into 5 samples and the second depleted sample fractionated into 3 samples.

Further, as noted above, it is not necessary that all fractions obtained by fractionating the samples used in the process are to be used to raise antibodies for subsequent depletion.

As noted above, the samples used in the process are fractionated according to a property of the molecules of the sample. In other words, the samples may be fractionated to remove molecules in the sample that have a particular physical characteristic. Thus, the sample may be fractionated to remove molecules in the sample that have a particular molecular weight, hydrophobicity, sugar or carbohydrate complexity and/or molecular charge. Molecular weight chromatography, for example, using gel exclusion columns, anion exchange chromatography, isoelectric focussing or 2 dimensional gel electrophoresis could be used for this purpose.

One important consideration in deciding whether to fractionate according to these properties, and the conditions for doing so, is that of the amount of protein or antigen to be obtained in the fractions. Generally speaking, one should seek to provide roughly the same amount of protein in each fraction. To do so, the molecules in the sample could be analysed by 2 dimensional gel electrophoresis and fractionated according to the relative protein distribution observed in each fraction.

It will be understood that it is not necessary to fractionate each sample according to the same property. For example, the test sample could be fractionated according to molecular weight, a first depleted sample could be fractionated according to molecular charge, and subsequent depleted samples could be fractionated according to hydrophobicity.

It will be understood that steps f) to g) of the process are particularly important as the antibodies produced therein permit the depletion of molecules that have a lower relative abundance than the molecules depleted in step e) and yet a higher relative abundance than the molecule having a low relative abundance in the test sample. One particular advantage is that low abundance molecules can be made visible, for example by 2 dimensional gel electrophoresis, by the process.

One particularly important advantage of the process is that it can be performed in a fashion whereby molecules that have a higher relative abundance than the target molecule are sequentially removed in each subsequent depletion step. For example, and as described further herein, the steps of using fractions of a sample as an immunogen to produce antibodies that are then used to deplete molecules from a sample that have a high relative abundance, thereby increasing relative abundance of a molecule that has a low relative abundance in the test sample, can be repeated multiple times. Accordingly, molecules having a higher relative abundance are depleted and the relative abundance of the molecules having the lower relative abundance is increased.

For example, for producing a third depleted sample, the process may include further steps of:

j) fractionating the sample produced by the depletion of the test sample with the first and second groups of antibodies (i.e. fractionating a “second depleted sample”) according to a property of the molecules of the second depleted sample to form at least two fractions of the second depleted sample;

k) providing a third population of hosts for producing a third group of antibodies for binding to molecules of the test sample that have a high relative abundance in each fraction of the second depleted sample;

l) introducing each fraction of the second depleted sample into a host of the third population so that each host of the third population receives one of the fractions of the second depleted ample, to produce the third group of antibodies;

m) utilising the first, second and third group of antibodies to deplete molecules from the test sample, to produce a third depleted sample.

In certain embodiments the process includes the step of providing conditions for denaturing a molecule in a sample to a second, third, fourth and further depleted samples.

It will be understood that the antibodies produced from each host of the population (for example each host of the first population) can be pooled and then the pool of the antibodies used in the depletion step. Alternatively, the antibodies from each host can be used sequentially to deplete the high relative abundance molecules from the test sample.

Further, it will be understood that the sample produced from the depletion of the test sample with the first and second groups of antibodies, or a pool of antibodies as described in the preceding paragraph, can be used to produce third and further groups of antibodies, which can be used sequentially with the first and second groups of antibodies, or in a composition including a pool of antibodies, to produce further depleted samples in which the relative abundance of the target molecule or low relative abundance molecule in the test sample is increased.

It will be understood that the first and second groups of antibodies may be used sequentially to deplete from the test sample the at least one species of molecule that has a higher relative abundance in the test sample than the low relative abundance molecule. In an alternative process, the first and second groups of antibodies are combined as in the form of a composition and the composition is then used to deplete from the test sample at least one species of molecule that has a higher relative abundance in the test sample than the low relative abundance molecule.

Thus in another aspect, the invention provides a process for increasing the relative abundance of a molecule having a low relative abundance in a test sample including:

a) providing conditions for denaturing a molecule in a test sample to a test sample;

b) fractionating the test sample according to a property of the molecules of the test sample, to form at least two fractions of the test sample;

c) providing a first population of hosts for producing a first group of antibodies for binding to molecules of the test sample that have a high relative abundance in each fraction of the test sample;

d) introducing each fraction of the test sample into a host of the first population so that each host of the first population receives one of the fractions of the test sample, to produce the first group of antibodies;

e) utilising the first group of antibodies to deplete molecules from the test sample, to produce a first depleted sample;

f) fractionating the first depleted sample according to a property of the molecules of the first depleted sample to form at least two fractions of the first depleted sample;

g) providing a second population of hosts for producing a second group of antibodies for binding to molecules of the test sample that have a high relative abundance in each fraction of the first depleted sample;

h) introducing each fraction of the first depleted sample into a host of the second population so that each host of the second population receives one of the fractions of the first depleted sample, to produce the second group of antibodies;

i) combining the first and second group of antibodies to form a first pool of antibodies;

j) utilising the first pool of antibodies to deplete molecules from the test sample, to increase the relative abundance of a molecule having a low relative abundance in a test sample.

In one embodiment the process includes the further step of providing conditions for denaturing a molecule in the first depleted sample to the first depleted sample prior to step h).

It will be understood that the sample produced from the depletion of the test sample with the first pool of antibodies, can be used to produce third and further groups of antibodies, which can be used sequentially with the first and second groups of antibodies, or in a composition including the first pool of antibodies, to produce further depleted samples.

Thus where the process includes the step of forming a first pool of antibodies for use in depleting a species of molecule that has a higher relative abundance in the test sample, the process includes the further steps of:

k) fractionating the sample produced by the depletion of the test sample with the first pool of antibodies (i.e. fractionating a “second depleted sample”) according to a property of the molecules of the second depleted sample to form at least two fractions of the second depleted sample;

l) providing a third population of hosts for producing a third group of antibodies for binding to molecules of the test sample that have a high relative abundance in each fraction of the second depleted sample;

m) introducing each fraction of the second depleted sample into a host of the third population so that each host of the third population receives one of the fractions of the second depleted ample, to produce the third group of antibodies;

n) utilising the first pool of antibodies and the third group of antibodies to deplete molecules from the test sample, to produce a third depleted sample.

In certain embodiments the process includes the step of providing conditions for denaturing a molecule in a sample to a second, third, fourth and further depleted samples.

In this embodiment, it will be understood that the first pool of antibodies and the third group of antibodies can be used sequentially, or alternatively, in the form of a composition, for example by combining the first pool of antibodies and the third group of antibodies to form a second pool of antibodies, to deplete from the test sample.

In another embodiment there is provided a process for increasing the relative abundance of a molecule having a low relative abundance in a test sample. The process includes the following steps:

a) fractionating the test sample according to a property of the molecules of the test sample, to form at least two fractions of the test sample;

b) providing a population of hosts for producing a group of antibodies for binding to molecules of the test sample that have a high relative abundance in each fraction of the test sample;

c) introducing each fraction of the test sample into a host of the population so that each host of the population receives one of the fractions of the test sample, to produce the group of antibodies;

d) utilising the group of antibodies to deplete molecules from the test sample in conditions in which a molecule in the test sample is denatured, to increase the relative abundance of a molecule having a low relative abundance in the test sample.

Typically the process includes the further steps of:

e) fractionating the first depleted sample according to a property of the molecules of the first depleted sample to form at least two fractions of the first depleted sample;

f) providing a second population of hosts for producing a second group of antibodies for binding to molecules of the test sample that have a high relative abundance in each fraction of the first depleted sample;

g) introducing each fraction of the first depleted sample into a host of the second population so that each host of the second population receives one of the fractions of the first depleted sample, to produce the second group of antibodies;

h) utilising the first group of antibodies and the second group of antibodies to deplete molecules from the test sample, to increase the relative abundance of a molecule having a low relative abundance in the test sample.

In one embodiment in step h), conditions in which a molecule of the test sample is denature are applied for depletion of a high relative abundance molecule from the sample with the first and second groups of antibodies.

For producing a third depleted sample, the process may include further steps of:

j) fractionating the sample produced by the depletion of the test sample with the first and second groups of antibodies (i.e. fractionating a “second depleted sample”) according to a property of the molecules of the second depleted sample to form at least two fractions of the second depleted sample;

k) providing a third population of hosts for producing a third group of antibodies for binding to molecules of the test sample that have a high relative abundance in each fraction of the second depleted sample;

l) introducing each fraction of the second depleted sample into a host of the third population so that each host of the third population receives one of the fractions of the second depleted ample, to produce the third group of antibodies;

m) utilising the first, second and third group of antibodies to deplete molecules from the test sample, to produce a third depleted sample.

Further, it will be understood that conditions in which a molecule of the test sample is denature may be applied for depletion of third and further groups or pools of antibodies to deplete molecules of high relative abundance from a sample.

In another embodiment there is provided a process for increasing the relative abundance of a molecule having a low relative abundance in a test sample. The process includes the following steps:

a) providing conditions for denaturing a molecule in a test sample to a test sample;

b) fractionating the test sample according to a property of the molecules of the test sample, to form at least two fractions of the test sample;

c) providing a population of hosts for producing a group of antibodies for binding to molecules of the test sample that have a high relative abundance in each fraction of the test sample;

d) introducing each fraction of the test sample into a host of the population so that each host of the population receives one of the fractions of the test sample, to produce the group of antibodies;

e) utilising the group of antibodies to deplete molecules from the test sample in conditions in which a molecule in the test sample is denatured, to increase the relative abundance of a molecule having a low relative abundance in the test sample.

Further, in certain embodiments the process includes the further step of providing conditions for denaturing a molecule in the first depleted sample to the first depleted sample prior to step d).

Further, in certain embodiments the process includes the step of providing conditions for denaturing a molecule in a sample to a second, third, fourth and further depleted samples.

The target molecule, or other molecules having a low relative abundance in a sample, are typically proteins. They may or may not be associated with carbohydrate. They are typically single chain proteins, however they may be associated with another peptide chain.

The target molecule may be any molecule capable of raising a humoral immune response. For example, the target molecule may be a carbohydrate, glycolipid or the like. Examples of such molecules include those capable of binding to natural antibodies.

The test sample for use in the process of the invention described herein may be any sample suitable for separation or identification by protein separation or identification techniques such as by 2 dimensional gel electrophoresis. Suitable samples include cell lysates, tissue lysates, organ lysates, organism lysates, body fluid samples, sub-cellular fractions, environmental samples and the like. Soluble fractions are typically used. Suitable fluid samples include cytoplasm, plasma, serum, whole blood, cerebrospinal fluid, synovial fluid, cervico-vaginal fluid and other tissue fluids, organ fluids such as bile, semen and the like; tumours; secretions such as mucinous fluids, exudates, saliva and tears; waste products, such as urine and perspiration and other biological fluids in the case of animals. For plants, micro-organisms and other such organisms, various other fluids, tissues and cell extracts can be used. Thus, plant tissue, such as leaf tissue, can be macerated in a suitable buffer to yield a suitable sample.

Where the sample is derived from an organism, to ensure that the antibodies that are produced are directed against proteins that have a higher relative abundance than the target molecule, it is important that organism used for producing the antibodies is phylogenetically distant from the organism from which the sample is derived. If the phylogenetic distance between the organism from which the sample is derived and the organism to be immunised is too close, antibodies are likely to be produced on the basis of other parameters, including complexity and relative antigenicity of the molecules in the sample.

As described herein, the inventor has found that where the organism from which the sample is derived is mammalian, for example, human and rodent, it is acceptable to use an avian species, such as a chicken to produce antibodies against the sample. The antibodies produced in such an immunisation tend to be those that react with proteins having a high relative abundance. It will be understood that other organisms having the same or greater phylogenetic distance, including other avian species and lizard species could be used.

Typically the species to be immunised with the sample is one that has diverged from the species from which the sample is obtained by at least 1 million years in evolutionary time. For example, an avian species such as a chicken is particularly useful for immunisation with a human derived sample as the divergence of such species is at least 2 million years in evolutionary time.

Examples of particularly useful chicken species and strains include white 1 Leghorn chickens. These are typically about 28 days old at the time of immunisation.

Processes for production and purification of chicken antibodies are known in the art, see for example Tini M. et al. 2002 “Generation and application of chicken egg-yolk antibodies” in Comparative Biochemistry and Physiology Part A 131: 5690574; Fisher M. et al 1996 “Comparison of standard methods for the preparation of egg yolk antibodies: in Tierarztl Prax. 24 (4): 411-8; Akita E M and S. Nakai 1993 in J. Immunol. Methods “Comparison of four purification methods for the production of immunoglobulins from eggs laid by hens immunized with an enterotoxigenic E. coli strain” 164(1): 141-142; Cuceanu N. et al. 1991 “Isolation and characterization of egg yolk antibodies IgY from hen immunized with different influenza virus strains” in Roum Arch Microbiol Immunol. 1991 50(3): 215-22; Polson A. 1990 “Isolation of IgY from the yolks of eggs by a chloroform polyethylene glycol procedure” in Immunol Invest 19)3): 253-8; Wallmann J et al. 1990 “A simple method for the isolation of immunoglobulin (y) from eggs of immunised hens” in Zentralbl Veterinarmed B. 37(4):317-20; Chang H et al. 2000 “Isolation of immunoglobulin from egg yolk by anionic polysaccharides” in J Agric Food Chem 48: 995-999; Veroliva A et al. 2000 “Affinity purification of immunoglobulins from chicken egg yolk using a new synthetic ligand” in J Chromatogr B Biomed Sci Appl 749(2): 233-42; Bizhanov G. and G. Vyshniauskis 2000 “A comparison of three methods for extracting IgY from the egg yolk of hens immunized with Sendai virus” in Vet Res Commun 24(2):103-13.

The antibody that is produced by immunisation with the sample and that is to be used for depletion can be of any class, subclass, single chain, and monofunctional, bifunctional or polyfunctional. The antibody can be intact or substantially intact, that is various portions of the antibody can be removed so long as the desired functions, such as antigen binding or Fc receptor binding is retained.

The antibody that is produced by immunisation with the sample and that is to be used for depletion, is a polysera. The polysera may contain antibodies that bind to more than one species of molecule that have a higher relative abundance in the sample than the target molecule. The polysera may contain antibodies that bind to different epitopes on the same species of molecule. The polysera may also contain polyreactive antibodies, that is, antibodies that are cross reactive and accordingly capable of binding to more than one type of epitope.

Examples of high relative abundance molecules that are removed from human serum when the process according to the invention is based on the immunisation of chickens include albumin, IgG, α-lipoprotein, β-lipoprotein, fibrinogen, transferrin, α1-antitrypsin, haptoglobin 2-1 type, α2-macroglobulin, IgA, ceruloplasmin, Ig M, α1 acid glycoprotein, c3-component, hemopexin, α2 HS-glycoprotein, inter-α 1-trypsin inhibitor, α1 antichymotrypsin, GC-globulin and IgD. The change in relative abundance accompanied by the depletion of these molecules according to the process of the invention is shown in Table 1.

The antibodies for depleting at least one species of molecule that has a higher relative abundance in the test sample than the target molecule are utilised by contacting the antibodies and the sample in conditions for permitting the antibodies to bind to at least one molecule having higher relative abundance in the sample than the target molecule. It is not necessary that all of the molecules having a higher relative abundance than the target molecule are removed from the sample, and it is not necessary that a species of molecule having a higher relative abundance than the target molecule be completely depleted or otherwise removed from the sample. Accordingly, the conditions for permitting the antibodies to bind to at least one molecule having a higher relative abundance in the sample than the target molecule are those that are sufficient to deplete an amount of the molecule so that the relative abundance of the target molecule is increased in the depleted sample. Examples of these conditions are described further herein. Suitable conditions for this purpose include those described in US 2002/0127739A.

It does not matter whether the antibodies are brought into contact with the sample, or whether the sample is brought into contact with the antibodies, for depletion of molecules having a relative abundance that is higher than the relative abundance of a target molecule in the sample. Typically, the sample is brought into contact with the antibodies.

In one particularly suitable form of the invention, the antibodies are immobilised on a solid phase by adsorption, covalent binding or entrapment in the solid phase, or by attachment to or incorporation on a coating for the solid phase. To facilitate re-use of the antibodies adsorbed on the solid phase, it is preferable that the antibodies are stably bound to the solid phase. Examples of solid phase supports for use in the invention and processes for arranging antibody on the supports are described in US 2002/0127739A. POROS™ (Applied Biosystems, Foster City, Calif.) chromatography media and continuous be matrices such as UNO™ (Bio-Rad Laboratories, Richmond Calif.) are particularly suitable. The solid support may be a matrix made of beads or microbeads of materials such as dextrans, styrenes, agarose, calcium phosphates, acrylics, polyamines, acrylamides or silicas. Once bound to the solid phase, the antibodies may be fixed covalently, for example using bifunctional crosslinking molecules such as glutaraldehyde, dimethyladipindate, dimethyl subserimidate, dimethyl pimlimidate, tetranitromethane and dimethyl 3,3′ dithiobisproprionimidate.

It will be understood that the antibody that is produced by immunisation may be utilised with one or more monoclonal antibodies to deplete molecules having a higher relative abundance than a target molecule from a sample. Monoclonal antibodies are powerful reagents because a clone can yield an antibody of high affinity, high avidity or both in essentially unlimited quantity and reproducible quality. Examples of monoclonal antibodies that could be used include antibodies that bind to albumin, IgG, transferrin, haptoglobin, alpha 1 antitrypsin, alpha 2 macroglobulin, IgA, IgM, alpha 1 acid glycoprotein, hemopexin, alpha 2 HS glycoprotein, alpha 1 antichymotrypsin, transthyretin and apo A1 lipoprotein.

Other reagents that could also be used to deplete molecules having a high relative abundance in a sample with the antibodies that are produced by immunisation with the sample include a specific binding partner or any receptor that specifically binds to the molecule having a higher relative abundance or other including lectins such as concanavalin A, wheat germ agglutinin, abrin and so on; metals; co-factors; combinatorial compounds, polymers, nucleic acids, artificial protein sequences and other compounds such as heparin, polymyxin, dyes such as Cibacron blue F3GA and hydrocarbons such as methyl and phenyl radicals that bind hydrophobic proteins, or agents comprising functional groups such as hydrazide, amine, N-hydroxy-succinimide, carboxyl, boronate and organomercury.

Any method that is capable of quantifying an amount of a molecule could be used to determine whether a particular target molecule has been enriched by the process of the invention. Examples of such methods include 2 dimensional gel electrophoresis, western blotting and densitometric analysis of the outputs of these methods. Alternative methods include ELISA and Bradford assay.

By permitting the relative abundance of a target molecule to be increased in a test sample, the process permits improved detection of molecules and provides purified forms of molecules and antibodies that bind thereto. Thus the invention is particularly important for providing process and means for example for detection or diagnosis of quality traits or disease in plants and animals and for detecting contaminants environmental samples, food samples and the like. There now follows a description of uses of the invention for identification, detection or otherwise diagnosis of molecules, and for producing purified forms of low abundance molecules and antibodies thereto.

Denaturants, or in other words, reagents for denaturing a molecule in a test sample, include reagents that are capable of denaturing proteins, peptides and the like. Examples of these reagents include detergents and chaotropes (i.e., strongly anionic or cationic compounds), including but not restricted to: 2-mercaptoethanol, SDS, other detergents, high salts (e.g., sodium chloride, guanidium hydrochloride urea, etc). Examples of reagents are shown in Timasheff S N, Xie G. Biophys Chem 2003 September; 105(2-3):421-48 Preferential interactions of urea with lysozyme and their linkage to protein denaturation.

It will be understood that in certain embodiments temperature and/or pressure conditions may be applied to denature a molecule in a test sample, with or without the above described reagents.

Where denaturing conditions are applied prior to depletion, conditions are selected for denaturation in which an antibody for depleting a high relative abundance molecule is not denatured. Examples of these conditions include 1-2M urea or dilute SDS.

A. Identifying and Detecting Low Relative Abundance Molecules

In certain embodiments there is provided a process for identifying or detecting a target molecule in a test sample. The process includes the following steps:

a) fractionating the test sample according to a property of the molecules of the test sample, to form at least two fractions of the test sample;

b) providing a first population of hosts for producing a first group of antibodies for binding to molecules of the test sample that have a high relative abundance in each fraction of the test sample;

c) introducing each fraction of the test sample into a host of the first population so that each host of the first population receives one of the fractions of the test sample, to produce the first group of antibodies;

d) utilising the first group of antibodies to deplete molecules from the test sample, to produce a first depleted sample;

e) fractionating the first depleted sample according to a property of the molecules of the first depleted sample to form at least two fractions of the first depleted sample;

f) providing a second population of hosts for producing a second group of antibodies for binding to molecules of the test sample that have a high relative abundance in each fraction of the first depleted sample;

g) introducing each fraction of the first depleted sample into a host of the second population so that each host of the second population receives one of the fractions of the first depleted sample, to produce the second group of antibodies;

h) utilising the first group of antibodies and the second group of antibodies to deplete molecules from the test sample, to identify or detect a target molecule in a test sample.

The process further includes the step of providing conditions for denaturing a molecule in a test sample to a test sample prior to step c) and/or providing conditions for denaturing a molecule in a first depleted sample to a first depleted sample prior to step g).

The process may additionally or alternatively include the step of depleting molecules from the test sample in step d) or step h) in conditions in which a molecule in the test sample is denatured.

In another embodiment there is provided a process for identifying or detecting a target molecule in a test sample. The process includes the following steps:

a) utilising the test sample to produce a first group of antibodies for binding to at least one species of molecule in the test sample that has a higher relative abundance in the sample than the target molecule;

b) utilising the first group of antibodies to deplete from the test sample at least one species of molecule that has a higher relative abundance in the test sample than the target molecule, to produce a first depleted sample;

c) utilising the first depleted sample to produce a second group of antibodies for binding to at least one species of molecule in the first depleted sample that has a higher relative abundance in the first depleted sample than the target molecule;

d) utilising the first and second groups of antibodies to deplete from the test sample at least one species of molecule that has a higher relative abundance in the test sample than the target molecule to produce a second depleted sample; and

e) analysing the second depleted sample to detect or identify the target molecule.

According to step e), the second depleted sample can be analysed by 2 dimensional gel electrophoresis, liquid chromatography, mass spectrometry (including ICAT-MS) HPLC, binding assays, staining etc.

To visualise the target molecule, it may be necessary to concentrate or lyophilise the second depleted sample.

The process further includes the step of providing conditions for denaturing a molecule in a test sample to a test sample prior to step a) and/or providing conditions for denaturing a molecule in a first depleted sample to a first depleted sample prior to step c).

The process may additionally or alternatively include the step of depleting molecules from the test sample in step b) or d) in conditions in which a molecule in the test sample is denatured.

B. Producing Purified Forms of Low Relative Abundance Molecules

In other embodiments there is provided a process for producing a purified form of a target molecule from a test sample. The process includes the following steps:

a) fractionating the test sample according to a property of the molecules of the test sample, to form at least two fractions of the test sample;

b) providing a first population of hosts for producing a first group of antibodies for binding to molecules of the test sample that have a high relative abundance in each fraction of the test sample;

c) introducing each fraction of the test sample into a host of the first population so that each host of the first population receives one of the fractions of the test sample, to produce the first group of antibodies;

d) utilising the first group of antibodies to deplete molecules from the test sample, to produce a first depleted sample;

e) fractionating the first depleted sample according to a property of the molecules of the first depleted sample to form at least two fractions of the first depleted sample;

f) providing a second population of hosts for producing a second group of antibodies for binding to molecules of the test sample that have a high relative abundance in each fraction of the first depleted sample;

g) introducing each fraction of the first depleted sample into a host of the second population so that each host of the second population receives one of the fractions of the first depleted sample, to produce the second group of antibodies;

h) utilising the first group of antibodies and the second group of antibodies to deplete molecules from the test sample, to produce a purified form of a target molecule from a test sample.

The process further includes the step of providing conditions for denaturing a molecule in a test sample to a test sample prior to step c) and/or providing conditions for denaturing a molecule in a first depleted sample to a first depleted sample prior to step g).

The process may additionally or alternatively include the step of depleting molecules from the test sample in step d) or step h) in conditions in which a molecule in the test sample is denatured.

In other embodiments there is provided a process for producing a purified form of a target molecule from a test sample. The process includes the following steps:

a) utilising the test sample to produce a first group of antibodies for binding to at least one species of molecule in the test sample that has a higher relative abundance in the sample than the target molecule;

b) utilising the first group of antibodies to deplete from the test sample at least one species of molecule that has a higher relative abundance in the test sample than the target molecule, to produce a first depleted sample;

c) utilising the first depleted sample to produce a second group of antibodies for binding to at least one species of molecule in the first depleted sample that has a higher relative abundance in the first depleted sample than the target molecule;

d) utilising the first and second groups of antibodies to deplete from the test sample at least one species of molecule that has a higher relative abundance in the test sample than the target molecule, to produce a purified form of the target molecule.

The process further includes the step of providing conditions for denaturing a molecule in a test sample to a test sample prior to step a) and/or providing conditions for denaturing a molecule in a first depleted sample to a first depleted sample prior to step c).

The process may additionally or alternatively include the step of depleting molecules from the test sample in step b) or step d) in conditions in which a molecule in the test sample is denatured.

C. Isolating Low Relative Abundance Molecules

In certain embodiments there is provided a process for isolating a target molecule from a sample including:

a) fractionating the test sample according to a property of the molecules of the test sample, to form at least two fractions of the test sample;

b) providing a first population of hosts for producing a first group of antibodies for binding to molecules of the test sample that have a high relative abundance in each fraction of the test sample;

c) introducing each fraction of the test sample into a host of the first population so that each host of the first population receives one of the fractions of the test sample, to produce the first group of antibodies;

d) utilising the first group of antibodies to deplete molecules from the test sample, to produce a first depleted sample;

e) fractionating the first depleted sample according to a property of the molecules of the first depleted sample to form at least two fractions of the first depleted sample;

f) providing a second population of hosts for producing a second group of antibodies for binding to molecules of the test sample that have a high relative abundance in each fraction of the first depleted sample;

g) introducing each fraction of the first depleted sample into a host of the second population so that each host of the second population receives one of the fractions of the first depleted sample, to produce the second group of antibodies;

h) utilising the first group of antibodies and the second group of antibodies to deplete molecules from the test sample, to isolate a target molecule from a sample.

The process further includes the step of providing conditions for denaturing a molecule in a test sample to a test sample prior to step c) and/or providing conditions for denaturing a molecule in a first depleted sample to a first depleted sample prior to step g).

The process may additionally or alternatively include the step of depleting molecules from the test sample in step d) or step h) in conditions in which a molecule in the test sample is denatured.

Thus the invention provides a process for isolating a target molecule from a sample including:

a) utilising the test sample to produce a first group of antibodies for binding to at least one species of molecule in the test sample that has a higher relative abundance in the sample than the target molecule;

b) utilising the first group of antibodies to deplete from the test sample at least one species of molecule that has a higher relative abundance in the test sample than the target molecule, to produce a first depleted sample;

c) utilising the first depleted sample to produce a second group of antibodies for binding to at least one species of molecule in the first depleted sample that has a higher relative abundance in the first depleted sample than the target molecule;

d) utilising the first and second groups of antibodies to deplete from the test sample at least one species of molecule that has a higher relative abundance in the test sample than the target molecule, to increase the relative abundance of the target molecule in the test sample; and

e) isolating the target molecule from the second depleted sample.

The process further includes the step of providing conditions for denaturing a molecule in a test sample to a test sample prior to step a) and/or providing conditions for denaturing a molecule in a first depleted sample to a first depleted sample prior to step c).

The process may additionally or alternatively include the step of depleting molecules from the test sample in step b) or step d) in conditions in which a molecule in the test sample is denatured.

The target molecule may be isolated from the second depleted sample with an antibody. Where an antibody is not available, the target molecule may be isolated by fractionating the second depleted sample, for example by 2 dimensional gel electrophoresis and the cutting the region containing the target molecule from the gel. The target molecule can then be eluted from the gel and used to raise an antibody to the target molecule. Alternatively, the target molecule can be sequenced, peptides can be prepared having regard to the determined sequence and antibodies raised to the peptides.

D. Producing Antibodies to Low Relative Abundance Molecules

Also provided is a process for producing an antibody that binds to a target molecule having a low relative abundance in a test sample including:

a) producing a sample that has a higher relative abundance of the target molecule than the test sample according to the embodiments of the invention disclosed herein;

b) utilising the produced sample to produce at least one antibody to the target molecule.

It will be understood that where some characteristic of the target molecule is known, the target molecule could be isolated from the sample that has a higher relative abundance of the target molecule, and the isolated molecule could then be used to produce at least one antibody to the target.

Thus in another aspect, the invention provides a process for producing an antibody that binds to a target molecule having a low relative abundance in a test sample including:

a) producing a sample that has a higher relative abundance of the target molecule than the test sample according to the embodiments disclosed herein;

b) isolating the target molecule from the produced sample; and

c) utilising the isolated target molecule to produce at least one antibody to the target molecule.

In certain embodiments there is provided an antibody produced by the above disclosed process and kit containing same.

1. A process for increasing the relative abundance of a target molecule in a test sample including:
a) providing conditions for denaturing a molecule in a test sample to a test sample;
b) utilising the test sample to produce a first group of antibodies for binding to at least one species of a molecule in the test sample that has a higher relative abundance in the test sample than a target molecule of the test sample;
c) utilising the first group of antibodies to deplete from the test sample at least one species of a molecule that has a higher relative abundance in the test sample than the target molecule, to produce a first depleted sample;
d) utilising the first depleted sample to produce a second group of antibodies for binding to at least one species of molecule in the first depleted sample that has a higher relative abundance in the first depleted sample than the target molecule; and
e) utilising the first and second groups of antibodies to deplete from the test sample at least one species of molecule that has a higher relative abundance in the test sample than the target molecule, to increase the relative abundance of the target molecule in the test sample.
